(19) United States
(12) Patent Application Publication
(10) Pub. No.: US 2024/0137844 A1
(43) Pub. Date: Apr. 25, 2024

(54) METHOD AND APPARATUS FOR CONFIGURING SSB BEAM SWEEPING PATTERN IN A WIRELESS COMMUNICATION SYSTEM

(71) Applicant: Samsung Electronics Co., Ltd., Gyeonggi-do (KR)

(72) Inventors: Changsung LEE, Gyeonggi-do (KR); Suhwook KIM, Gyeonggi-do (KR); Hyeondeok JANG, Gyeonggi-do (KR)

(21) Appl. No.: 18/469,992

(22) Filed: Sep. 19, 2023

(30) Foreign Application Priority Data
Oct. 14, 2022 (KR) 10-2022-0132249

(51) Int. Cl. H04W 48/08; H04W 24/10

(52) U.S. Cl. CPC H04W 48/08; H04W 24/10

(57) ABSTRACT

The present disclosure relates to a 5G communication system or a 6G communication system for supporting higher data rates beyond a 4G communication system such as long term evolution (LTE). A method performed by a base station in a wireless communication system may include determining a first synchronization signal block (SSB) beam sweeping pattern, based on distribution of a plurality of user equipments (UEs), transmitting information indicating the first SSB beam sweeping pattern to a neighbor base station and the plurality of UEs, transmitting an SSB to the plurality of UEs, based on the first SSB beam sweeping pattern, receiving information about an SSB beam sweeping pattern of the neighboring base station from the neighbor base station, receiving parameter information for updating the first SSB beam sweeping pattern from a core network, updating the first SSB beam sweeping pattern to a second SSB beam sweeping pattern, based on second location information received in response to a request transmitted to the plurality of UEs, based on the parameter information, transmitting information indicating the second SSB beam sweeping pattern to the neighbor base station and the plurality of UEs, and transmitting an SSB to the plurality of UEs, based on the second SSB beam sweeping pattern.

### CROSS-REFERENCE TO RELATED APPLICATION(S)

This application is based on and claims priority under 35 U.S.C. § 119 to Korean Patent Application No. 10-2022-0132249, filed on Oct. 14, 2022, in the Korean Intellectual Property Office, the entire disclosure of which is incorporated herein by reference.

### BACKGROUND

### 1. Field

The disclosure relates to a wireless communication system and, more particularly, to a method and an apparatus for configuring a synchronization signal block (SSB) beam sweeping pattern in a wireless communication system.

### 2. Description of Related Art

Considering the development of wireless communication from generation to generation, technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to more severe path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio Frequency (RF) elements, antennas, novel waveforms having a better coverage than orthogonal frequency division multiplexing (OFDM), beamforming and massive multiple-input multiple-output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive eXtended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Beamforming is a technique that concentrates a signal using a plurality of antenna elements. Conventional beamforming follows a beam sweeping method that moves a beam only according to a predetermined pattern during beamforming, and there is a demand for improving this conventional omnidirectional beamforming

### SUMMARY

Various embodiments disclosed herein provide a method and an apparatus for configuring, based on the location of a UE, an SSB beam sweeping pattern in a wireless communication system.

According to an embodiment, a method performed by a base station in a wireless communication system may include determining a first synchronization signal block (SSB) beam sweeping pattern, based on distribution of a plurality of user equipments (UEs), transmitting information indicating the first SSB beam sweeping pattern to a neighbor base station and the plurality of UEs, transmitting an SSB to the plurality of UEs, based on the first SSB beam sweeping pattern, receiving information about an SSB beam sweeping pattern of the neighbor base station from the neighbor base station, receiving parameter information for updating the first SSB beam sweeping pattern from a core network, updating the first SSB beam sweeping pattern to a second SSB beam sweeping pattern, based on second location information received in response to a request transmitted to the plurality of UEs, based on the parameter information, transmitting information indicating the second SSB beam sweeping pattern to the neighbor base station and the plurality of UEs, and transmitting an SSB to the plurality of UEs, based on the second SSB beam sweeping pattern.

According to an embodiment, an apparatus of a base station in a wireless communication system may include a transceiver and at least one processor, the at least one processor configured to determine a first synchronization signal block (SSB) beam sweeping pattern, based on distribution of a plurality of user equipments (UEs), transmit information indicating the first SSB beam sweeping pattern to a neighbor base station and the plurality of UEs, transmit an SSB to the plurality of UEs, based on the first SSB beam sweeping pattern, receive information about an SSB beam sweeping pattern of the neighbor base station from the neighbor base station, receive parameter information for updating the first SSB beam sweeping pattern from a core network, update the first SSB beam sweeping pattern to a second SSB beam sweeping pattern, based on second location information received in response to a request transmitted to the plurality of UEs, based on the parameter information, transmit information indicating the second SSB beam sweeping pattern to the neighbor base station and the plurality of UEs, and transmit an SSB to the plurality of UEs, based on the second SSB beam sweeping pattern.

According to an embodiment, a method performed by a user equipment (UE) in a wireless communication system may include transmitting first location information to a base station, receiving configuration information about a first synchronization signal block (SSB) beam sweeping pattern from the base station, receiving an SSB based on the first SSB beam sweeping pattern from the base station, transmitting second location information to the base station, receiving information indicating an update of the first SSB beam sweeping pattern to a second SSB beam sweeping pattern from the base station, and receiving an SSB based on the second SSB beam sweeping pattern from the base station.

According to an embodiment, an apparatus of a user equipment (UE) in a wireless communication system may include a transceiver and at least one processor, the at least one processor may be configured to transmit first location information to a base station, receive configuration information about a first synchronization signal block (SSB) beam sweeping pattern from the base station, receive an SSB based on the first SSB beam sweeping pattern from the base station, transmit second location information to the base station, receive information indicating an update of the first SSB beam sweeping pattern to a second SSB beam sweeping pattern from the base station, and receive an SSB based on the second SSB beam sweeping pattern from the base station.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating allocation of an SSB in a wireless communication system according to an embodiment;

FIG. 2 illustrates a configured SSB beam sweeping pattern according to an embodiment;

FIG. 3 is a flowchart of a base station-UE pre-operation according to an embodiment;

FIG. 4 illustrates a process in which a base station configures an SSB beam sweeping pattern according to an embodiment;

FIG. 5 illustrates an SSB beam sweeping pattern configured by a base station according to an embodiment;

FIG. 6 is a flowchart illustrating a base station-UE operation according to an embodiment;

FIG. 7 illustrates an operation of a base station configuring an SSB beam sweeping pattern according to an embodiment;

FIG. 8 illustrates an SSB beam sweeping pattern of a base station according to an embodiment;

FIG. 9 illustrates an operation of a base station according to an embodiment;

FIG. 10 illustrates a selective SSB reception operation of a UE according to an embodiment;

FIG. 11 illustrates an operation of a UE according to an embodiment;

FIG. 12 illustrates an SSB allocation structure according to an embodiment;

FIG. 13 illustrates a structure of a base station according to an embodiment; and

FIG. 14 illustrates a structure of a UE according to an embodiment.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even a term defined in the disclosure should not be interpreted to exclude embodiments of the disclosure.

In the following description, terms referring to signals (e.g., message, signal, signaling, sequence, and stream), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MACCE), and radio access control (RRC) signaling), terms referring to network entities, terms referring to device elements, and the like are illustratively used for the sake of convenience. Therefore, the disclosure is not limited by the terms as used below, and other terms referring to subjects having equivalent technical meanings may be used.

Various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self-contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment. A wireless terminal can be a subscriber station, wireless device, cellular telephone, PCS telephone, cordless telephone, a session initiation protocol (SIP) phone, a wireless local loop (WLL) station, a personal digital assistant (PDA), a handheld device having wireless connection capability, or other processing device connected to a wireless modem. A base station (e.g., access point) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the same meanings as the contextual meanings in the relevant field of art, and are not to be interpreted to have ideal or excessively formal meanings unless clearly defined in the disclosure.

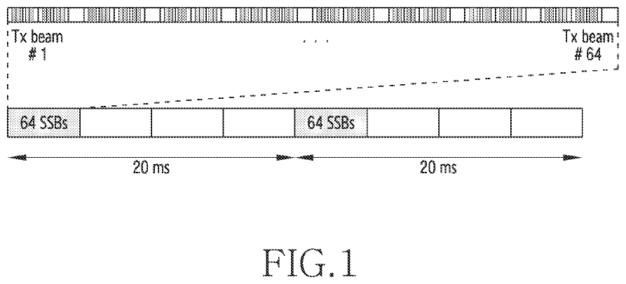

FIG. 1 is a block diagram illustrating allocation of an SSB in a wireless communication system according to an embodiment.

Referring to FIG. 1, a synchronization signal block (SSB) burst set is illustrated. The SSB burst set may include a plurality of SSBs. In FIG. 1, one SSB burst set may include 64 SSBs, and the SSB burst set may have periodicity of being located every 20 ms period.

The SSB burst set including the plurality of SSBs may be used for search for a cell formed by a base station and an access procedure. A UE may determine physical cell identity (PCI) from a primary synchronization signal (PSS) and a secondary synchronization signal (SSS) of an SSB. The UE may determine a system frame number (SFN), an SSB index value, and a half-frame bit from a physical broadcast channel (PBCH) of the SSB or a master information block (MIB). The UE may receive a system information block (SIB)1 message or information, and may determine the periodicity of the SSB burst set, based on the SIB1 message or the information. The UE may determine SSB burst set information, based on the information, and the SSB burst set information may include locations and timings of the SSBs in the SSB burst set. Accordingly, the UE may monitor the SSBs in the SSB burst set.

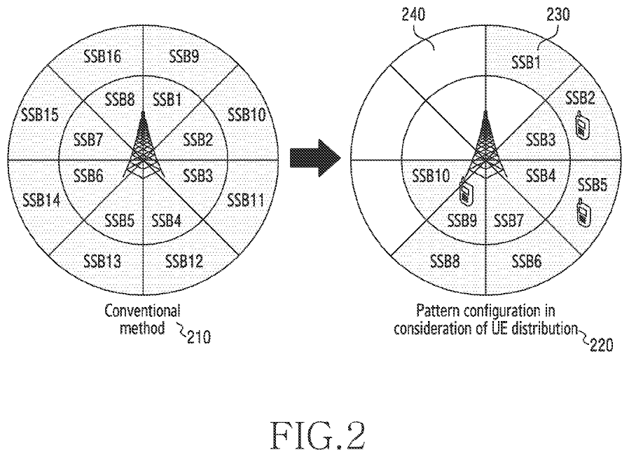

FIG. 2 illustrates a configured SSB beam sweeping pattern according to an embodiment.

A conventional SSB beam sweeping pattern 210 is a method in which a base station transmits an SSB in all directions not only in an area in which a UE exists but also in an area in which no UE exists. For example, referring to FIG. 2, according to the conventional SSB beam sweeping pattern 210, one base station transmits SSBs to all areas of a cell formed by the base station, and thus SSB indexes SSB1 to SSB16 may be transmitted to the cell. Since the base station transmits an SSB in all directions, overhead of unnecessarily transmitting an SSB even to an area in which no UE exists may be incurred. The UE may measure an SSB in an area in which no other UE exists, thus consuming unnecessary power, which may incur overhead of the UE.

When the base station is capable of configuring a sweeping pattern of an SSB beam in consideration of distribution of a UE, the base station may transmit an SSB only to the area in which the UE exists and an area adjacent to the area, thereby reducing overhead of the base station. Further, when the UE receives a sweeping pattern of an SSB beam configured by the base station in consideration of distribution of UEs, the UE may selectively measure an SSB by changing a measurement parameter related to the sweeping pattern of the SSB beam configured by the base station, and thus power consumption and overhead of the UE may be reduced.

In FIG. 2, an SSB beam sweeping pattern 220 configured by the base station in consideration of distribution of UEs may enable the base station to transmit an SSB only to the area in which the UE exists and the adjacent area in consideration of the area in which the UE exists. For example, the base station may transmit an SSB to a first area 230, in which there is an adjacent UE, but may not transmit an SSB to a second area 240, in which there is no adjacent UE. Accordingly, the base station may transmit SSB indexes SSB1 to SSB10 according to the SSB beam sweeping pattern 220 configured in consideration of the distribution of UEs.

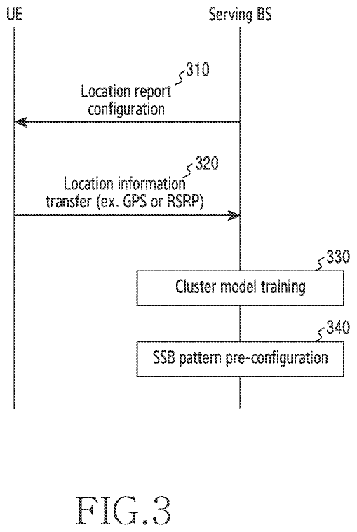

FIG. 3 is a flowchart of a base station-UE pre-operation according to an embodiment.

Referring to FIG. 3, a serving base station may transmit a message for configuring a report of location information about a UE to the UE located in a cell formed by the serving base station at operation 310. The message for configuring the report of the location information about the UE may include the type of location information (e.g., a global positioning system (GPS) coordinate and reference signal received power (RSRP) data) that the UE reports to the base station and configuration information about a reporting period in which the UE reports the location information to the base station.

Upon receiving a location report configuration message from the serving base station, the UE may transmit the location information about the UE to the serving base station at operation 320. The location information about the UE may include a GPS coordinate, RSRP data, and the like. The UE that transmits the location information to the serving base station may include not only a UE in a connected state but also a UE in an idle state and a UE in an inactive state. That is, a UE in the idle state or the inactive state may periodically measure an SSB, and may transmit location information the serving base station when transitioning to the connected state according to a period.

In addition to transmitting the message including content to report the location information to the UE, the base station may obtain the location information about the UE by using a serving beam index (e.g., a transmission configuration indication (TCI)) of the UE.

The serving base station may learn distribution of UEs by using an AI model at operation 330. For example, the serving base station may perform clustering so that distributions of UEs determined to be the same or similar are included in the same cluster, based on location information about UEs received from the UEs, by using the AI model. Specifically, the base station may generate a UE distribution chart sample in which locations of UEs distributed at each specific time are represented as a latitude and a longitude, based on the location information about the UEs received from the UEs. When the AI model determines similarity between generated UE distribution chart samples, a Euclidean distance or cosine similarity may be used. Further, the serving base station may perform clustering, based on various AI algorithms. For example, the serving base station may learn a cluster model, based on a K-means clustering algorithm The serving base station may calculate a cluster centroid vector in consideration of an average of distribution chart samples within the clusters, and may display a UE distribution chart displaying a representative UE distribution per cluster. A criterion for determining whether a representative UE distribution is displayed may be configured in advance. For example, a distribution chart sample having a shortest Euclidean distance to the cluster centroid vector may be determined as the UE distribution chart displaying the representative UE distribution. In another example, the base station may learn a UE distribution chart displaying a representative UE distribution at a specific time by using the AI model or a mapping table. Specifically, the base station may configure the AI model to learn a UE distribution by time by using the AI model, or may configure generation of a mapping table displaying a UE distribution by time. Subsequently, the base station may generate a representative UE distribution chart by using the AI model or the mapping table. A criterion for determining whether a representative UE distribution is displayed may be configured in advance.

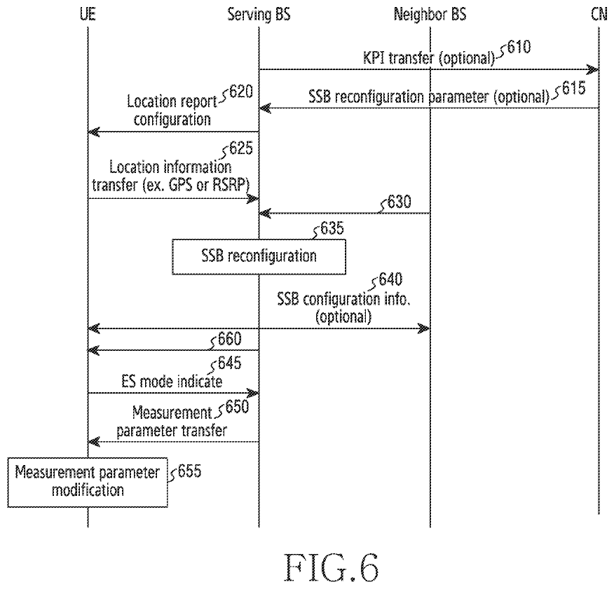

The serving base station may pre-configure an SSB beam sweeping pattern based on the UE distribution chart learned using the AI model at operation 340. Hereinafter, specific details will be described with reference to FIG. 6.

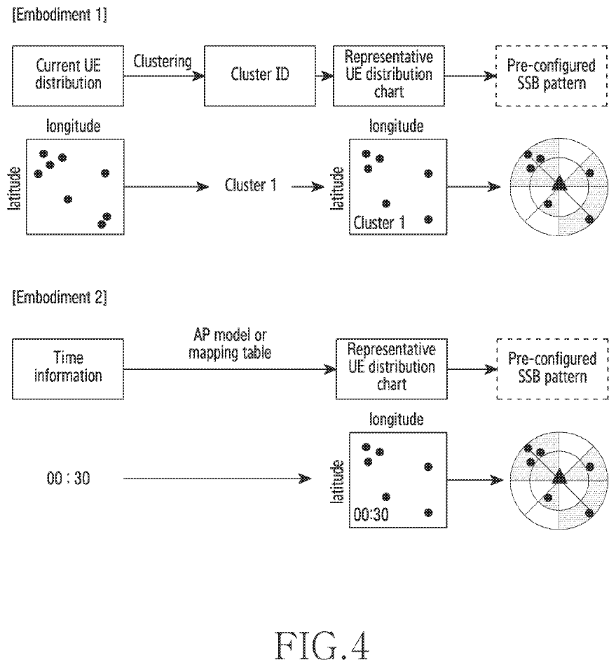

FIG. 4 illustrates a process in which a base station configures an SSB beam sweeping pattern according to an embodiment.

Referring to FIG. 4, in Embodiment 1, the base station may generate a distribution chart in which locations of UEs distributed at each specific time are represented as a latitude and a longitude, based on location information about the UEs received from the UEs. The base station may configure an ID of a cluster to which the distribution chart of the UEs belongs by using a trained AI model. For example, the base station may calculate a Euclidean distance between the distribution chart of the UEs and a cluster centroid vector, and may configure an ID of a cluster having a shortest distance as the ID of the cluster to which the distribution chart of the UEs belongs. Subsequently, the base station may import a representative UE distribution chart configured for each cluster ID by using the trained AI model, and may select a most suitable pattern among pre-configured SSB beam sweeping patterns, based on the UE distribution chart, thereby configuring an SSB beam sweeping pattern.

In Embodiment 2 of FIG. 4, the base station may import a UE distribution chart displaying a representative UE distribution at a specific time by using a trained AI model or a mapping table. The base station may configure an SSB beam sweeping pattern, based on a representative UE distribution chart.

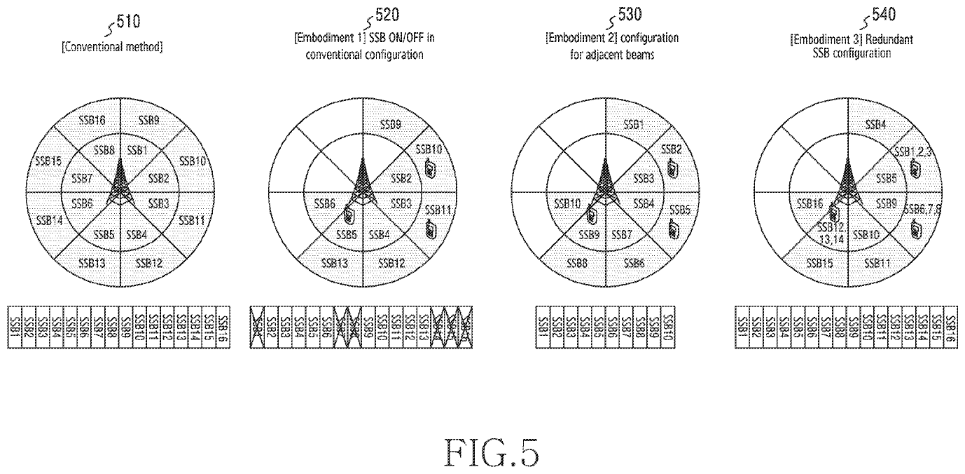

FIG. 5 illustrates an SSB beam sweeping pattern configured by a base station according to an embodiment.

The base station may pre-configure an SSB beam sweeping pattern, based on a representative UE distribution chart generated based on location information about a UE. Specifically, the base station may map an area in a cell to which an SSB is transmitted, based on the representative UE distribution chart. A plurality of SSB beam sweeping patterns may be mapped one-to-many and configured according to different periods.

Referring to FIG. 5, an operation of pre-configuring an SSB beam sweeping pattern may be performed as operations 520, 530, and 540 of Embodiment 1 to Embodiment 3.

The base station provides a communication service for a specific geographic area (generally referred to as a cell). A cell may be divided into a plurality of areas.

Embodiment 1 520 of FIG. 5 illustrates an operation of turning off a specific SSB not to transmit only the specific SSB is not transmitted in a conventional SSB pattern configuration in which the base station is configured to transmit an SSB to all areas in a cell. For example, in SSB1 to SSB16 in which SSBs are conventionally allocated, the base station may turn off an SSB (SSB1, SSB7, SSB8, and SSB14 to SSB16) allocated to an area in which no UE exists, based on a representative UE distribution chart. Since no SSB is transmitted in the area in which the SSB is turned off, unnecessary SSB transmission by the base station may be reduced. Since the operation of the base station according to Embodiment 1 does not require a change of SSB configuration information, there may be no overhead due to the change of the SSB configuration information.

This embodiment may be understood as a first pattern of skipping transmission of an SSB for an area in which a small number of UEs are distributed among all SSBs.

Embodiment 2 530 of FIG. 5 illustrates an operation in which the base station configures an SSB beam sweeping pattern by grouping adjacent SSB beams. Specifically, the base station may configure an SSB beam sweeping pattern so that adjacent SSB beams form a group, based on a representative UE distribution. For example, the base station may configure a pattern to transmit an SSB by configuring adjacent SSB1 to SSB3 as group 1, SSB4 to SSB7 as group 2, and SSB8 to SSB10 as group 3. Here, the length of an SSB burst set may be reduced. The operation of the base station according to Embodiment 2 may simultaneously transmit SSB beams to an area in which a specific UE is located and an adjacent area, thereby efficiently measuring the UE.

This embodiment may be understood as a second pattern of omitting transmission of an SSB for an area in which a small number of UEs are distributed among all SSBs.

Embodiment 3 540 of FIG. 5 illustrates an operation in which the base station configures an SSB beam sweeping pattern of transmitting redundant SSBs to an area in which a UE exists. Specifically, in a conventional SSB pattern configuration in which the base station is configured to transmit an SSB to all areas in a cell, redundant SSBs may be configured for the area of the cell where a UE is located. For example, in SSB indexes SSB1 to SSB16 in which SSBs are conventionally allocated, the base station may transmit redundant SSBs of SSB1 to SSB3, SSB6 to SSB8, and SSB12 to SSB14 respectively to three areas of the cell where a UE exists, based on a representative UE distribution chart. Here, the length of an SSB burst set may be maintained. The operation of the base station according to Embodiment 3 may improve SSB measurement performance through rapid Rx beam sweeping of a UE.

This embodiment may be understood as a third pattern of repeatedly transmitting an SSB for an area in which a large number of UEs are distributed among all SSBs.

According to an embodiment, the base station may transmit information about an SSB index that is repeatedly transmitted to the same area to a plurality of UEs. The plurality of UEs may receive information indicating an SSB beam sweeping pattern of the third pattern, based on the information about the SSB index.

FIG. 6 is a flowchart illustrating a base station-UE operation according to an embodiment. A UE typically belongs to one cell formed by a base station. The cell to which the UE belongs is referred to as a serving cell, and the base station providing a service through the serving cell is referred to as a serving base station.

Referring to FIG. 6, the serving base station may transmit information including a network key performance indicator (KPI) to a network entity of a core network (CN) at operation 610. The network KPI may include the following parameters, but is not limited thereto:
Number of UEs that have failed in initial connection
Number of UEs in connected state
Cell IP throughput
Mobility KPI (e.g., HO success rate)

Upon receiving the information including the network KPI from the serving base station, the core network may transmit information including parameters for reconfiguring an SSB beam sweeping pattern to the serving base station at operation 615. The parameters for reconfiguring the SSB beam sweeping pattern may include the following values, but are not limited thereto:
Period in which SSB beam sweeping pattern is reconfigured
Configuration information for reporting location information about UE (e.g., location information type and reporting period)
Proportional fairness (PF) metric parameter
Whether to notify neighbor base station of reconfigured SSB beam sweeping pattern

In addition to receiving the foregoing parameters from the core network, the base station may hold pre-configured parameters as configured value when the base station is established, and may receive fixed parameter values configured by an operator when deploying a random access network (RAN).

The serving base station may transmit a message for configuring a report of location information about a UE to the UE located in a cell formed by the serving base station at operation 620. The message may include the type of location information (e.g., a global positioning system (GPS) coordinate and reference signal received power (RSRP) data) that the UE reports to the base station and configuration information about a reporting period in which the UE reports the location information to the base station.

The network entity which the serving base station transmits the information to and receives the information from in operations 610 and 620 may be a network data analytics function (NWDAF) entity of the core network, but may also be another network entity of the core network.

In addition to transmitting the message including content to report the location information to the UE, the base station may obtain the location information about the UE by using a serving beam index (e.g., a transmission configuration indication (TCI)) of the UE.

Upon receiving the message for configuring the report of the location information about the UE, the UE may transmit the location information about the UE to the serving base station at operation 625. The location information about the UE may include a GPS coordinate, RSRP data, and the like. The UE that transmits the location information to the serving base station may include not only a UE in a connected state but also a UE in an idle state and a UE in an inactive state. A UE in the idle state or the inactive state may transmit location information the serving base station when transitioning to the connected state according to a period. The UE in the idle state or the inactive state may periodically measure an SSB even at a standstill.

The serving base station may receive information including parameters for reconfiguring an SSB beam sweeping pattern from a neighbor base station adjacent to the serving base station at operation 630. The parameters for reconfiguring the SSB beam sweeping pattern may include the following values, but are not limited thereto:
SSB beam sweeping pattern of neighbor base station
Location information about neighbor base station

The serving base station may reconfigure an SSB beam sweeping pattern, based on the information including the parameters for reconfiguring the SSB beam sweeping pattern received from the core network and the neighbor base station and the location information about the UE received from the UE at operation 635. An operation of the base station reconfiguring the SSB beam sweeping pattern may also be considered as an operation of updating the SSB beam sweeping pattern.

According to an embodiment, the base station may select one of a plurality of pre-configured SSB beam sweeping patterns, based on the information including the parameters and a reported UE distribution. The selected SSB beam sweeping pattern may be considered as a reconfigured SSB beam sweeping pattern. The selected SSB beam sweeping pattern may be an SSB beam sweeping pattern that most closely corresponds to the parameters received by the base station and the location information about the UE.

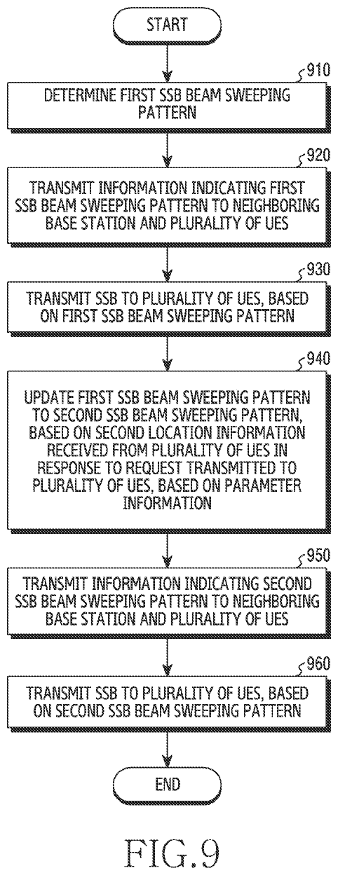

The base station may update an SSB beam sweeping pattern pre-configured in a pre-operation in real time, based on the reported UE distribution, thereby updating the SSB beam sweeping pattern. For example, the base station may schedule an SSB beam by using the proportional fairness (PF) metric parameter received from the core network, thereby updating the SSB beam sweeping pattern in real time. Hereinafter, a detailed description will be made with reference to FIG. 9.

The serving base station may notify the neighbor base station of information about the reconfigured SSB beam sweeping pattern at operation 640. When reconfiguring the SSB beam sweeping pattern of the neighbor base station, the neighbor base station may consider the information about the reconfigured SSB beam sweeping pattern of the serving base station received from the serving base station.

The serving base station may transmit an SSB to the UE according to the determined SSB beam sweeping pattern at operation 660. The transmitted SSB beam sweeping pattern may be any one of the SSB beam sweeping patterns described in FIG. 5. The transmitted SSB beam sweeping pattern may also be an SSB beam sweeping pattern updated in real time by using the PF metric parameter in addition to the SSB beam sweeping patterns described in FIG. 5.

The serving base station may also notify the information about the reconfigured SSB beam sweeping pattern to the UE that has reported the location information. When receiving and measuring an SSB, the UE may consider the information about the reconfigured SSB beam sweeping pattern of the serving base station received from the serving base station.

Operations 645 to 655 refer to the UE selectively measuring the SSB.

The UE may notify the base station whether to operate in an energy saving (ES) mode at operation 645.

When the UE operates in the ES mode, the base station may transmit measurement parameters related to the SSB beam sweeping pattern whenever the SSB beam sweeping pattern is reconfigured at operation 650. The measurement parameters may include the following values, but are not limited thereto:
SSB measurement timing configuration (SMTC) offset
SMTC window
SSB measurement period information

According to an embodiment, even when updating the SSB beam sweeping pattern in real time, the base station may transmit measurement parameters related to the updated SSB beam sweeping pattern to the UE.

The UE may reconfigure measurement parameters for SSB measurement of the UE, based on the measurement parameters related to the SSB beam sweeping pattern received from the base station at operation 655.

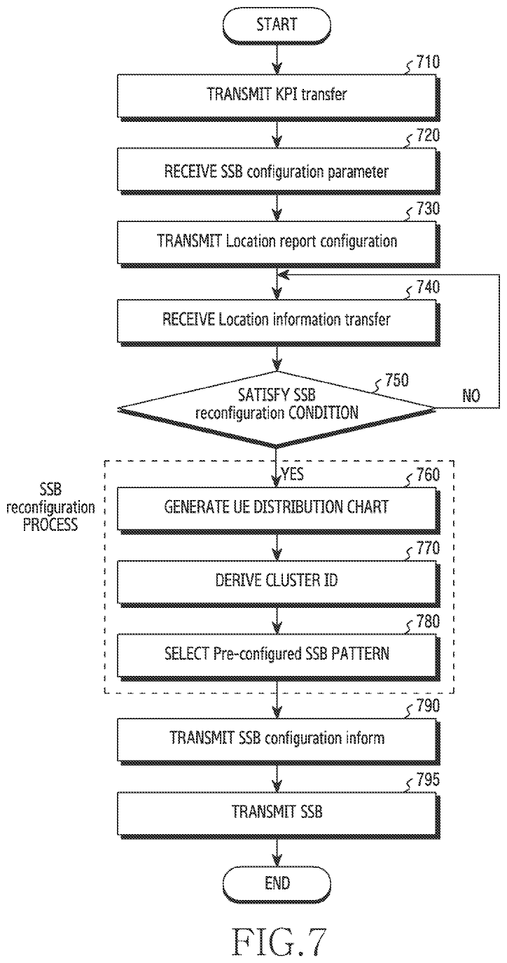

FIG. 7 illustrates an operation of configuring an SSB beam sweeping pattern of a base station according to an embodiment.

Referring to FIG. 7, in step 710, the base station may transmit information including a KPI to a core network. The network KPI may include the following parameters, but is not limited thereto:
Number of UEs that have failed in initial connection
Number of UEs in connected state
Cell IP throughput
Mobility KPI (e.g., HO success rate)

In step 720, the base station may receive information including parameters for reconfiguring an SSB beam sweeping pattern from the core network. The parameters for reconfiguring the SSB beam sweeping pattern may include the following values, but are not limited thereto:
Period in which SSB beam sweeping pattern is reconfigured
Configuration information for reporting location information about UE (e.g., location information type and reporting period)
Proportional fairness (PF) metric parameter
Whether to notify neighbor base station of reconfigured SSB beam sweeping pattern

In addition to receiving the foregoing parameters from the core network, the base station may hold pre-configured parameters as configured value when the base station is established, and may receive fixed parameter values configured by an operator when deploying a RAN.

In step 730, the base station may transmit a message for configuring a report of location information about a UE to the UE. The message may include the type of location information (e.g., a global positioning system (GPS) coordinate and reference signal received power (RSRP) data) that the UE reports to the base station and configuration information about a reporting period in which the UE reports the location information to the base station.

In addition to transmitting the message including content to report the location information to the UE, the base station may obtain the location information about the UE by using a serving beam index (e.g., a transmission configuration indication (TCI)) of the UE.

In step 740, the base station may receive the location information about the UE from the UE. The location information about the UE may include a GPS coordinate, RSRP data, and the like. The UE that transmits the location information to the serving base station may include not only a UE in a connected state but also a UE in an idle state and a UE in an inactive state. A UE in the idle state or the inactive state may transmit location information the serving base station when transitioning to the connected state according to a period. The UE may periodically measure an SSB even in the idle state or the inactive state.

The serving base station may perform clustering so that distributions of UEs determined to be the same or similar are included in the same cluster, based on location information about UEs received from the UEs, by using an AI model. Specifically, the base station may generate a UE distribution chart sample in which locations of UEs distributed at a specific time are represented as a latitude and a longitude, based on the location information about the UEs received from the UEs. When the AI model determines similarity between generated UE distribution chart samples, a Euclidean distance or cosine similarity may be used. Further, the serving base station may perform clustering, based on various AI algorithms. For example, the serving base station may learn a cluster model, based on a K-means clustering algorithm The serving base station may calculate a cluster centroid vector in consideration of an average of distribution chart samples within the clusters, and may display a UE distribution chart displaying a representative UE distribution per cluster. A criterion for determining whether a representative UE distribution is displayed may be configured in advance. For example, a distribution chart sample having a shortest Euclidean distance to the cluster centroid vector may be determined as the UE distribution chart displaying the representative UE distribution.

In step 750, the base station may determine whether to reconfigure an SSB beam sweeping pattern. In one example, the base station may determine whether to reconfigure the SSB beam sweeping pattern, based on whether a condition for reconfiguring a pre-configured SSB beam sweeping pattern is satisfied. In another example, the base station may determine whether to reconfigure the SSB beam sweeping pattern, based on the information including the parameters for reconfiguring the SSB beam sweeping pattern received from the core network and the neighbor base station and the location information about the UE.

When the base station reconfigures the SSB beam sweeping pattern, step 760 may be performed. When determining that the condition for reconfiguring the SSB beam sweeping pattern is not satisfied, the base station may additionally receive the location information about the UE from the UE in step 740.

An operation of the base station reconfiguring the SSB beam sweeping pattern are described in steps 760 to 780 of FIG. 7.

In step 760, to reconfigure the SSB beam sweeping pattern, the base station may generate a distribution chart in which locations of UEs distributed at each specific time are represented as a latitude and a longitude, based on the location information about the UEs received from the UEs.

In step 770, the base station may configure an ID of a cluster to which the distribution chart of the UEs belongs by using the trained AI model. For example, the base station may calculate a Euclidean distance between the distribution chart of the UEs and a cluster centroid vector, and may configure an ID of a cluster having a shortest distance as the ID of the cluster to which the distribution chart of the UEs belongs.

In step 780, the base station may import a representative UE distribution chart configured for each cluster ID by using the trained AI model, and may select a most suitable pattern among pre-configured SSB beam sweeping patterns, based on the UE distribution chart, thereby reconfiguring the SSB beam sweeping pattern.

The base station may update an SSB beam sweeping pattern pre-configured in a pre-operation in real time, based on a reported UE distribution, thereby reconfiguring the SSB beam sweeping pattern. For example, the base station may schedule an SSB beam by using the PF metric parameter received from the core network, thereby updating the SSB beam sweeping pattern in real time.

In step 790, the base station may notify the neighbor base station of information about the reconfigured SSB beam sweeping pattern. When reconfiguring the SSB beam sweeping pattern of the neighbor base station, the neighbor base station may consider the information about the reconfigured SSB beam sweeping pattern of the serving base station received from the serving base station.

The serving base station may also notify the information about the reconfigured SSB beam sweeping pattern to the UE that has reported the location information. When receiving and measuring an SSB, the UE may consider the information about the reconfigured SSB beam sweeping pattern of the serving base station received from the serving base station.

In step 795, the serving base station may transmit an SSB to the UE according to the determined SSB beam sweeping pattern. The transmitted SSB beam sweeping pattern may be any one of the SSB beam sweeping patterns described in FIG. 5. The transmitted SSB beam sweeping pattern may also be an SSB beam sweeping pattern updated in real time by using the PF metric parameter in addition to the SSB beam sweeping patterns described in FIG. 5.

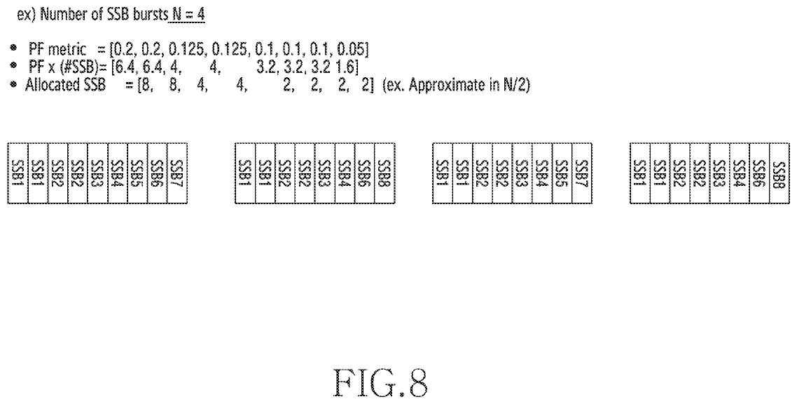

FIG. 8 illustrates an SSB beam sweeping pattern of a base station according to an embodiment.

The base station may update an SSB beam sweeping pattern pre-configured in a pre-operation in real time, based on a reported UE distribution, thereby reconfiguring the SSB beam sweeping pattern. For example, in FIG. 8, the base station may schedule an SSB beam by using a PF metric parameter received from a core network, thereby updating the SSB beam sweeping pattern in real time. The PF metric parameter may be needed to satisfy both throughput and fairness by preventing resource allocation from being concentrated on a specific SSB in an area in which a large number of UEs are located and allocating a certain quantity of resources to all SSBs while the base station schedules an SSB.

When the number of SSB bursts, which means a set of consecutive SSBs, is N, the base station may schedule an allocated SSB by using the number of SSB bursts and the PF metric parameter. The value of the PF metric parameter may be defined by Equation (1).

$${P}_{i} = \frac{{R}_{i , t}^{α}}{{A}_{i , t}^{β}} \qquad ( 1 )$$

R_{i,t} denotes a value obtained by dividing a value of the number of UEs connecting to a SSB i plus 1 by the total number of UEs connecting a current cell. An SSB to which a large number of UEs belong may have a higher PF metric value. A_{i,t}^{β} denotes a probability that the SSB i is selected and transmitted on average during a specific period T. An SSB that is not smoothly transmitted during the specific period may have a higher PF metric value. α, β, and T denote PF metric parameters received from the core network.

The base station may calculate a value obtained by multiplying a PF metric value calculated according to Equation (1) by the total number of SSBs to be allocated, and may approximate a calculated result in a pre-configured approximation unit, thereby determining an SSB allocation unit. The pre-configured approximation unit may be, for example, the number of SSB bursts divided by 2, which is N/2.

FIG. 8 illustrates an example of configuring an SSB beam sweeping pattern by scheduling an SSB allocated when the number of SSB bursts is N=4. The PF metric value calculated according to Equation (1) is [0.2, 0.2, 0.125, 0.125, 0.1, 0.1, 0.1, 0.05]. Subsequently, the calculated PF metric value is multiplied by 32, which is the total number of SSBs to be allocated, resulting in [6.4, 6.4, 4, 4, 3.2, 3.2, 3.2, 1.6]. The calculated result is approximated in a unit of 2, which is a value of N/2, and thus SSBs allocated per SSB burst may be scheduled as [8, 8, 4, 4, 2, 2, 2, 2]. An SSB burst set may be used for a procedure in which a UE searches for and connects to a cell formed by the base station.

FIG. 9 illustrates an operation of a base station according to an embodiment.

Referring to FIG. 9, in step 910, the base station may determine a first SSB beam sweeping pattern, based on distribution of a plurality of UEs. Specifically, the base station may receive first location information about each UE from the plurality of UEs. The first location information may be location information about the UE that the base station may receive from the UE in a process of pre-configuring an SSB beam sweeping pattern. The first location information may include a global positioning system (GPS) coordinate and reference signal received power (RSRP) data of the UE. The location information about the UE may be obtained not only by the base station transmitting a message such that the UE reports the location information about the UE but also by using a serving beam index (e.g., a transmission configuration indication (TCI)) of the UE.

The base station may learn distribution of the at least one UE, based on the received first location information, by using an AI model. For example, the serving base station may perform clustering so that distributions of UEs determined to be the same or similar are included in the same cluster, based on location information about UEs received from the UEs, by using the AI model. Specifically, the base station may generate a UE distribution chart sample in which locations of UEs distributed at each specific time are represented as a latitude and a longitude, based on the location information about the UEs received from the UEs. When the AI model determines similarity between generated UE distribution chart samples, a Euclidean distance or cosine similarity may be used. Further, the serving base station may perform clustering, based on various AI algorithms. For example, the serving base station may learn a cluster model, based on a K-means clustering algorithm. The serving base station may calculate a cluster centroid vector in consideration of an average of distribution chart samples within the clusters, and may display a UE distribution chart displaying a representative UE distribution per cluster. A criterion for determining whether a representative UE distribution is displayed may be configured in advance. For example, a distribution chart sample having a shortest Euclidean distance to the cluster centroid vector may be determined as the UE distribution chart displaying the representative UE distribution.

The base station may pre-configure an SSB beam sweeping pattern, based on the learned distribution of the UE. The pre-configured SSB beam sweeping pattern may be referred to as a first SSB beam sweeping pattern.

In step 920, the base station may transmit information indicating the first SSB beam sweeping pattern to the plurality of UEs to a neighbor base station and the plurality of UEs.

In step 930, the base station may transmit an SSB to the plurality of UEs, based on the first SSB beam sweeping pattern. Accordingly, the plurality of UEs may receive the SSB transmitted by the base station.

The base station may receive information about an SSB beam sweeping pattern from the neighbor base station adjacent to the base station. Parameters for reconfiguring an SSB beam sweeping pattern may include the following values, but are not limited thereto:
SSB beam sweeping pattern of neighbor base station
Location information about neighbor base station

The base station may receive information including a parameter for updating the first SSB beam sweeping pattern from a core network.

According to an embodiment, before receiving the information, to receive the information including the parameter for updating the first SSB beam sweeping pattern, the base station may transmit at least one of the number of UEs that have failed in initial connection, the number of UEs connected to the base station, and a cell IP throughput to a network entity, based on a key performance indicator (KPI).

The base station may determine whether to update the first SSB beam sweeping pattern to a second SSB beam sweeping pattern, based on the information including the parameter and second location information. When the base station determines to update the first SSB beam sweeping pattern to the second SSB beam sweeping pattern, the base station may perform step 940. When the base station determines not to update the first SSB beam sweeping pattern to the second SSB beam sweeping pattern, the base station may terminate the operation.

In step 940, the base station may update the first SSB beam sweeping pattern to the second SSB beam sweeping pattern, based on the second location information received from the plurality of UEs in response to a request transmitted to the plurality of UEs based on the information including the parameter received from the core network.

The second location information may be location information about the UE needed for the base station to reconfigure an SSB beam sweeping pattern. In step 950, the base station may transmit information indicating the second SSB beam sweeping pattern to the neighbor base station and the plurality of UEs.

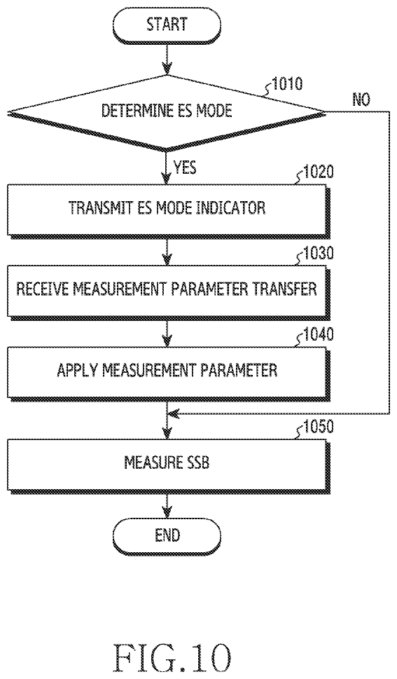

In step 960, the base station may transmit an SSB to the plurality of UEs, based on the second SSB beam sweeping pattern. Accordingly, the plurality of UEs may receive the SSB transmitted by the base station. Hereinafter, an SSB reception operation of a UE will be described with reference to FIG. 10.

FIG. 10 illustrates a selective SSB reception operation of a UE according to an embodiment. FIG. 10 shows an operation of the UE in operations 645 to 655 of FIG. 6 in detail.

Referring to FIG. 10, in step 1010, the UE may determine whether to operate in an ES mode. After a base station reconfigures an SSB beam sweeping pattern, the UE receiving information about the reconfigured SSB beam sweeping pattern may notify the base station whether to operate in the ES mode in order to receive a selective SSB.

In step 1020, the UE may notify the base station of information including an indicator indicating whether to operate in the ES mode. For example, when the UE operates in the ES mode, the UE may notify the base station of information indicating that the indicator has a value of 1.

In step 1030, the UE may receive measurement parameters related to the SSB beam sweeping pattern from the base station notified of the information including the indicator indicating that the UE operates in the ES mode. The measurement parameters related to the SSB beam sweeping pattern may include the following values, but are not limited thereto:
SMTC offset
SMTC window
SMTC period information

SMTC offset information may include information associated with a start point of an SMTC window within an SMTC period, and SMTC window information may include the length of the SMTC window for the UE to receive an SSB within the SMTC period. The length of the SMTC window may be at least part of the length of an SSB burst or longer. The SMTC period information may include a period for the UE to receive an SSB.

According to an embodiment, even when the UE does not notify the base station whether the UE operates in the ES mode, the UE may receive the measurement parameters related to the SSB beam sweeping pattern from the base station.

In step 1040, the UE may reconfigure measurement parameters for SSB measurement of the UE, based on the measurement parameters related to the SSB beam sweeping pattern received from the base station.

In step 1050, the UE may selectively measure an SSB, based on the reconfigured measurement parameters for the SSB measurement.

The UE may determine the period, length, and start time of an SMTC window by using SMTC offset information, SMTC window information, and SMTC period information of a reconfigured measurement parameter received from the base station. The UE may measure an SSB in the determined SMTC window.

Since the UE selectively measures an SSB, power consumption of the UE may be reduced, and thus overhead of the UE may be reduced.

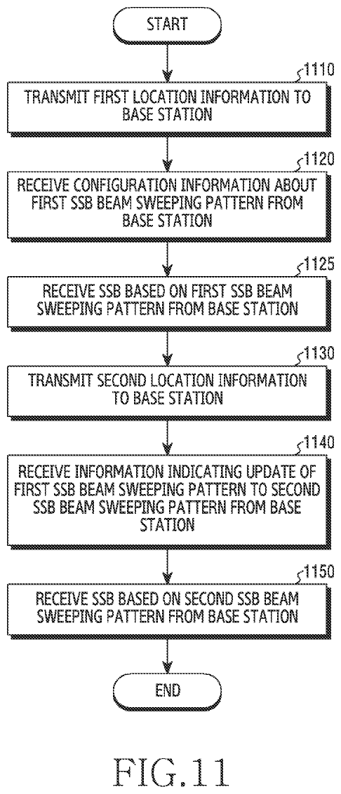

FIG. 11 illustrates an operation of a UE according to an embodiment.

Referring to FIG. 11, in step 1110, the UE may transmit first location information to a base station. The first location information may be location information about the UE that the base station may receive from the UE in a process of pre-configuring an SSB beam sweeping pattern. The first location information may include a global positioning system (GPS) coordinate and reference signal received power (RSRP) data of the UE.

In step 1120, the UE may receive configuration information about a first SSB beam sweeping pattern from the base station. The first SSB beam sweeping pattern may refer to an SSB beam sweeping pattern pre-configured by the base station in a pre-operation.

In step 1125, the UE may receive an SSB based on the first SSB beam sweeping pattern from the base station.

In step 1130, the UE may transmit second location information about the UE to the base station. The second location information may refer to location information about the UE needed for the base station to reconfigure an SSB beam sweeping pattern. The second location information may include a global positioning system (GPS) coordinate and reference signal received power (RSRP) data of the UE.

In step 1140, the UE may receive information indicating an update of the first SSB beam sweeping pattern to a second SSB beam sweeping pattern from the base station.

In step 1150, the UE may selectively receive an SSB, based on the received second SSB beam sweeping pattern. Hereinafter, a selective SSB reception operation of the UE is the same as that described with reference to FIG. 10.

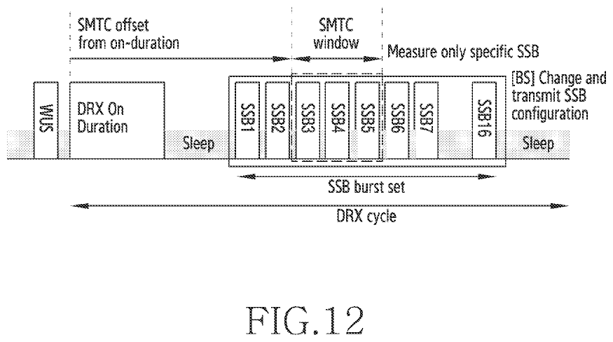

FIG. 12 illustrates a configured SSB allocation structure according to an embodiment.

A UE may receive measurement parameters related to SSB measurement from a base station, and the measurement parameters may include the following values, but are not limited thereto:
SMTC offset
SMTC window
SMTC period information

SMTC offset information may include information associated with a start point of an SMTC window within an SMTC period, and SMTC window information may include the length of the SMTC window for the UE to receive an SSB within the SMTC period. The length of the SMTC window may be at least part of the length of an SSB burst or longer. The SMTC period information may include a period for the UE to receive an SSB.

The UE may measure an SSB, based on the received measurement parameters. According to an embodiment, the UE may determine the period, length, and start time of an SMTC window by using SMTC offset information, SMTC window information, and SMTC period information of a reconfigured measurement parameter received from the base station. The UE may measure an SSB in the determined SMTC window.

Since the UE selectively measures an SSB, power consumption of the UE may be reduced, and thus overhead of the UE may be reduced.

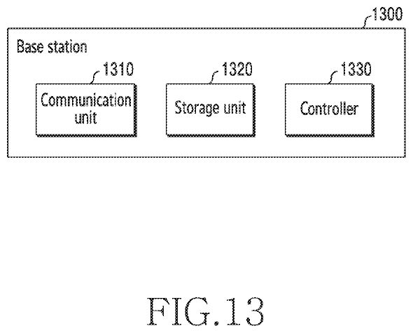

FIG. 13 illustrates a structure of a base station according to an embodiment.

Referring to FIG. 13, the base station 1300 includes a communication unit 1310, a storage unit 1320, and a controller 1330.

The communication unit 1310 performs functions for transmitting or receiving a signal through a wireless channel For example, the communication unit 1310 performs a function of conversion between a baseband signal and a bit stream according to the physical layer specification of a system. In data transmission, the communication unit 1310 encodes and modulates a transmitted bit stream to generate complex symbols. Further, in data reception, the communication unit 1310 demodulates and decodes a baseband signal to reconstruct a received bit stream. The communication unit 1310 upconverts a baseband signal into an RF band signal to transmit the RF band signal through an antenna, and downconverts an RF band signal, received through the antenna, into a baseband signal.

To this end, the communication unit 1310 may include a transmission filter, a reception filter, an amplifier, a mixer, an oscillator, a digital-to-analog converter (DAC), an analog-to-digital converter (ADC), or the like. Further, the communication unit 1310 may include a plurality of transmission and reception paths. In addition, the communication unit 1310 may include at least one antenna array including a plurality of antenna elements. From the aspect of hardware, the communication unit 1310 may include a digital unit and an analog unit, and the analog unit may include a plurality of sub-units according to operating power, operating frequency, or the like.

The communication unit 1310 may transmit and receive a signal. To this end, the communication unit 1310 may include at least one transceiver. For example, the communication unit 1310 may transmit a synchronization signal, a reference signal, system information, a message, control information, or data. Further, the communication unit 1310 may perform beamforming

As described above, the communication unit 1310 transmits and receives a signal. Accordingly, part or all of the communication unit 1310 may be referred to as a transmitter, a receiver, or a transceiver. As described herein, transmission and reception performed through a wireless channel are construed as including processing performed as above by the communication unit 1310.

The storage unit 1320 stores data, such as a default program, an application, and configuration information, for the operation of the base station. The storage unit 1320 may include a memory. The storage unit 1320 may be configured as a volatile memory, a nonvolatile memory, or a combination of a volatile memory and a nonvolatile memory. The storage unit 1320 provides the stored data in response to a request from the controller 1330.

The controller 1330 controls the overall operation of the base station 1300. For example, the controller 1330 transmits and receives a signal through the communication unit 1310. Further, the controller 1330 records and reads data in the storage unit 1320. The controller 1330 may perform functions of a protocol stack required by the communication standards. To this end, the controller 1330 may include at least one processor.

A configuration of the base station 1300 illustrated in FIG. 13 is only one example of the base station, and an example of the base station performing various embodiments is not limited by the configuration illustrated in FIG. 13. That is, some components may be added, deleted, or changed.

Although the base station 1300 is described as one entity in FIG. 13, the disclosure is not limited thereto. The base station 1300 may be configured to form an access network having not only an integrated deployment but also a distributed deployment. The base station may be divided into a central unit (CU) and a digital unit (DU), and may be configured such that the CU functions as an upper layer (e.g., packet data convergence protocol (PDCP) and RRC) and the DU functions as a lower layer (e.g., medium access control (MAC) and physical (PHY)). The DU of the base station may form beam coverage on a wireless channel

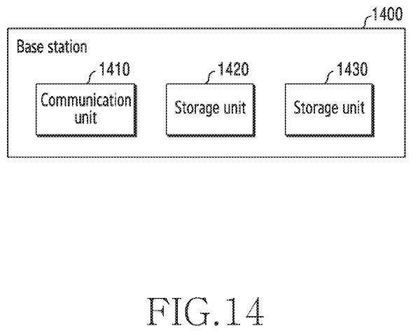

FIG. 14 illustrates a structure of a UE 1400 according to an embodiment.

Referring to FIG. 14, the UE 1400 includes a communication unit 1410, a storage unit 1420, and a controller 1430.

The communication unit 1410 performs functions for transmitting or receiving a signal through a wireless channel For example, the communication unit 1410 performs a function of conversion between a baseband signal and a bit stream according to the physical layer specification of a system. In data transmission, the communication unit 1410 encodes and modulates a transmitted bit stream to generate complex symbols. Further, in data reception, the communication unit 1410 demodulates and decodes a baseband signal to reconstruct a received bit stream. The communication unit 1410 upconverts a baseband signal into an RF band signal to transmit the RF band signal through an antenna, and downconverts an RF band signal, received through the antenna, into a baseband signal. For example, the communication unit 1410 may include a transmission filter, a reception filter, an amplifier, a mixer, an oscillator, a DAC, an ADC, or the like.

Further, the communication unit 1410 may include a plurality of transmission and reception paths. In addition, the communication unit 1410 may include an antenna unit. The communication unit 1410 may include at least one antenna array including a plurality of antenna elements. From the aspect of hardware, the communication unit 1410 may include a digital circuit and an analog circuit (e.g., a radio frequency integrated circuit (RFIC)). The digital circuit and the analog circuit may be configured as one package. The communication unit 1410 may include a plurality of RF chains. The communication unit 1410 may perform beamforming The communication unit 1410 may apply a beamforming weight to a signal to be transmitted or received in order to impart directivity according to a configuration of the controller 1430 to the signal. According to an embodiment, the communication unit 1410 may include an RF block (or RF unit). The RF block may include first RF circuitry related to an antenna and second RF circuitry related to baseband processing. The first RF circuitry may be referred to as an RF-antenna (RF-A). The second RF circuitry may be referred to as an RF-baseband (RF-B).

The communication unit 1410 may transmit and receive a signal. To this end, the communication unit 1410 may include at least one transceiver. The communication unit 1410 may receive a downlink signal. The downlink signal may include a synchronization signal (SS), a reference signal (RS) (e.g., a demodulation (DM)-RS and a phase tracking reference signal (PTRS)), system information (e.g., an MIB, an SIB, remaining system information (RMSI), and other system information (OSI)), a configuration message, control information, or downlink data. The communication unit 1410 transmit an uplink signal. The uplink signal may include a random access-related signal (e.g., a random access preamble (RAP) (or message 1 (Msg 1) or message 3 (Msg 3)), a reference signal (e.g., a sounding reference signal (SRS), a DMRS, and a PTRS), or a power headroom report (PHR).

The communication unit 1410 may include different communication modules to process signals in different frequency bands. Further, the communication unit 1410 may include a plurality of communication modules to support a plurality of different wireless access technologies. For example, the different wireless access technologies may include Bluetooth low energy (BLE), wireless fidelity (Wi-Fi), Wi-Fi gigabyte (WiGig), a cellular network (e.g., long-term evolution (LTE), new radio (NR)), and the like. The different frequency bands may include a super high frequency (SHF) (e.g., 2.5 GHz or 5 GHz) band and a millimeter-wave (e.g., 38 GHz and 60 GHz) band. The communication unit 1410 may use the same type of wireless access technology in different frequency bands (e.g., an unlicensed band for licensed assisted access (LAA) and a citizens broadband radio service (CBRS) (e.g., 3.5 GHz)).

As described above, the communication unit 1410 transmits and receives a signal. Accordingly, part or all of the communication unit 1410 may be referred to as a transmitter, a receiver, or a transceiver. As described herein, transmission and reception performed through a wireless channel are construed as including processing performed as above by the communication unit 1410.

The storage unit 1420 stores data, such as a default program, an application, and configuration information, for the operation of the UE 1400. The storage unit 1420 may be configured as a volatile memory, a nonvolatile memory, or a combination of a volatile memory and a nonvolatile memory. The storage unit 1420 provides the stored data in response to a request from the controller 1430.

The controller 1430 controls the overall operation of the UE 1400. For example, the controller 1430 transmits and receives a signal through the communication unit 1310. Further, the controller 1430 records and reads data in the storage unit 1420. The controller 1430 may perform functions of a protocol stack required by the communication standards. To this end, the controller 1430 may include at least one processor. The controller 1430 may include at least one processor or microprocessor, or may be part of a processor. Part of the communication unit 1410 and the controller 1430 may be referred to as a communication processor (CP). The controller 1430 may include various modules for performing communication. The controller 1430 may control the UE to perform operations according to various embodiments.

The embodiments disclosed in this specification and drawings are provided only as illustrative examples to easily describe technical details of the disclosure and help understanding of the disclosure, and are not intended to limit the scope of the disclosure. That is, it will be obvious to those skilled in the art to which the disclosure pertains that other modifications based on the technical idea of the disclosure may be carried out. The above embodiments may be combined with each other as needed.

As described above, a method performed by a base station in a wireless communication system according to various embodiments disclosed herein may include determining a first synchronization signal block (SSB) beam sweeping pattern, based on distribution of a plurality of user equipments (UEs), transmitting information indicating the first SSB beam sweeping pattern to a neighbor base station and the plurality of UEs, transmitting an SSB to the plurality of UEs, based on the first SSB beam sweeping pattern, receiving information about an SSB beam sweeping pattern of the neighbor base station from the neighbor base station, receiving parameter information for updating the first SSB beam sweeping pattern from a core network, updating the first SSB beam sweeping pattern to a second SSB beam sweeping pattern, based on second location information received in response to a request transmitted to the plurality of UEs, based on the parameter information, transmitting information indicating the second SSB beam sweeping pattern to the neighbor base station and the plurality of UEs, and transmitting an SSB to the plurality of UEs, based on the second SSB beam sweeping pattern.

According to various embodiments disclosed herein, the determining of the first SSB beam sweeping pattern may include learning the distribution of the plurality of UEs, based on first location information received from the plurality of UEs and an AI model, and the learning of the distribution of the plurality of UEs based on the AI model may include clustering, by the AI model, the distribution of the plurality of UEs, based on the first location information and generating a representative UE distribution chart, based on a clustering result.

According to various embodiments disclosed herein, the parameter information may be received from a network entity of the core network, and the parameter information may include at least one of a number of UEs that have failed in initial connection, a number of UEs connected to the base station, and a cell IP throughput, and may be received based on a key performance indicator (KPI) transmitted to the network entity.

According to various embodiments disclosed herein, each of the first SSB sweeping pattern and the second SSB beam sweeping pattern may be determined based on a proportional fairness metric for the plurality of UEs, and each of the first SSB sweeping pattern and the second SSB beam sweeping pattern may be one of a first pattern of skipping transmission of an SSB for an area in which a small number of UEs are distributed among all SSBs, a second pattern of omitting transmission of an SSB for an area in which a small number of UEs are distributed among all of the SSBs, or a third pattern of repeatedly transmitting an SSB for an area in which a large number of UEs are distributed among all of the SSBs.

According to various embodiments disclosed herein, the first location information may include at least one of a global positioning system (GPS) coordinate, reference signal received power (RSRP) data, and a transmission configuration indication (TCI) state of the UEs.

As described above, an apparatus of a base station in a wireless communication system according to various embodiments disclosed herein may include a transceiver and at least one processor, the at least one processor is configured to determine a first synchronization signal block (SSB) beam sweeping pattern, based on distribution of a plurality of user equipments (UEs), transmit information indicating the first SSB beam sweeping pattern to a neighbor base station and the plurality of UEs, transmit an SSB to the plurality of UEs, based on the first SSB beam sweeping pattern, receive information about an SSB beam sweeping pattern of the neighbor base station from the neighbor base station, receive parameter information for updating the first SSB beam sweeping pattern from a core network, update the first SSB beam sweeping pattern to a second SSB beam sweeping pattern, based on second location information received in response to a request transmitted to the plurality of UEs, based on the parameter information, transmit information indicating the second SSB beam sweeping pattern to the neighbor base station and the plurality of UEs, and transmit an SSB to the plurality of UEs, based on the second SSB beam sweeping pattern.

According to various embodiments disclosed herein, the at least one processor may be configured to determine the first SSB beam sweeping pattern by learning the distribution of the plurality of UEs, based on first location information received from the plurality of UEs and an AI model, cluster, by the AI model, the distribution of the plurality of UEs, based on the first location information, and generate a representative UE distribution chart, based on a clustering result.

According to various embodiments disclosed herein, the parameter information may be received from a network entity of the core network, and the parameter information may include at least one of a number of UEs that have failed in initial connection, a number of UEs connected to the base station, and a cell IP throughput, and is received based on a key performance indicator (KPI) transmitted to the network entity.

According to various embodiments disclosed herein, each of the first SSB sweeping pattern and the second SSB beam sweeping pattern may be determined based on a proportional fairness metric for the plurality of UEs, and each of the first SSB sweeping pattern and the second SSB beam sweeping pattern may be one of a first pattern of skipping transmission of an SSB for an area in which a small number of UEs are distributed among all SSBs, a second pattern of omitting transmission of an SSB for an area in which a small number of UEs are distributed among all of the SSBs, or a third pattern of repeatedly transmitting an SSB for an area in which a large number of UEs are distributed among all of the SSBs.

According to various embodiments disclosed herein, the first location information may include at least one of a global positioning system (GPS) coordinate, reference signal received power (RSRP) data, and a transmission configuration indication (TCI) state of the UEs.

As described above, a method performed by a user equipment (UE) in a wireless communication system according to various embodiments disclosed herein may include transmitting first location information to a base station, receiving configuration information about a first synchronization signal block (SSB) beam sweeping pattern from the base station, receiving an SSB based on the first SSB beam sweeping pattern from the base station, transmitting second location information to the base station, receiving information indicating an update of the first SSB beam sweeping pattern to a second SSB beam sweeping pattern from the base station, and receiving an SSB based on the second SSB beam sweeping pattern from the base station.

According to various embodiments disclosed herein, the transmitting of the second location information may be performed based on receiving a request message for updating the first SSB beam sweeping pattern to the second SSB beam sweeping pattern from the base station.

According to various embodiments disclosed herein, the method may further include transmitting a message regarding whether to perform an energy saving (ES) mode to the base station.

According to various embodiments disclosed herein, the method may further include receiving a measurement parameter including at least one of an SMTC offset, an SMTC window, and a measurement period from the base station.

According to various embodiments disclosed herein, the first location information may include at least one of a global positioning system (GPS) coordinate, reference signal received power (RSRP) data, and a transmission configuration indication (TCI) state of the UE.

As described above, an apparatus of a user equipment (UE) in a wireless communication system according to various embodiments disclosed herein may include a transceiver and at least one processor, the at least one processor may be configured to transmit first location information to a base station, receive configuration information about a first synchronization signal block (SSB) beam sweeping pattern from the base station, receive an SSB based on the first SSB beam sweeping pattern from the base station, transmit second location information to the base station, receive information indicating an update of the first SSB beam sweeping pattern to a second SSB beam sweeping pattern from the base station, and receive an SSB based on the second SSB beam sweeping pattern from the base station.

According to various embodiments disclosed herein, the at least one processor may be configured to transmit the second location information, based on receiving a request message for updating the first SSB beam sweeping pattern to the second SSB beam sweeping pattern from the base station.

According to various embodiments disclosed herein, the at least one processor may be configured to transmit a message regarding whether to perform an energy saving (ES) mode to the base station.

According to various embodiments disclosed herein, the at least one processor may be configured to receive a measurement parameter including at least one of an SMTC offset, an SMTC window, and a measurement period from the base station.

According to various embodiments disclosed herein, the first location information may include at least one of a global positioning system (GPS) coordinate, reference signal received power (RSRP) data, and a transmission configuration indication (TCI) state of the UE.

While the present disclosure has been shown and described with reference to various embodiments of the present disclosure, those skilled in the art may appreciate that, without departing from the spirit and scope of the present disclosure as defined by the appended claims and their equivalents, variations may be made to the form and detail thereof.

What is claimed is:

1. A method performed by a base station in a wireless communication system, the method comprising:
determining a first synchronization signal block (SSB) beam sweeping pattern, based on distribution of a plurality of user equipments (UEs);
transmitting information indicating the first SSB beam sweeping pattern to a neighbor base station and the plurality of UEs;
transmitting an SSB to the plurality of UEs, based on the first SSB beam sweeping pattern;
receiving information about an SSB beam sweeping pattern of the neighbor base station from the neighbor base station;
receiving parameter information for updating the first SSB beam sweeping pattern from a core network;
updating the first SSB beam sweeping pattern to a second SSB beam sweeping pattern, based on second location information received in response to a request transmitted to the plurality of UEs, based on the parameter information;
transmitting information indicating the second SSB beam sweeping pattern to the neighbor base station and the plurality of UEs; and
transmitting an SSB to the plurality of UEs, based on the second SSB beam sweeping pattern.

2. The method of claim 1,
wherein determining the first SSB beam sweeping pattern comprises learning the distribution of the plurality of UEs, based on first location information received from the plurality of UEs and an artificial intelligence (AI) model, and
wherein learning the distribution of the plurality of UEs based on the AI model comprises:
clustering, by the AI model, the distribution of the plurality of UEs, based on the first location information; and
generating a representative UE distribution chart, based on a clustering result.

3. The method of claim 1, wherein the parameter information is received from a network entity of the core network, and
wherein the parameter information comprises at least one of a number of UEs that have failed in initial connection, a number of UEs connected to the base station, and a cell IP throughput, and is received based on a key performance indicator (KPI) transmitted to the network entity.

4. The method of claim 1, wherein each of the first SSB sweeping pattern and the second SSB beam sweeping pattern is determined based on a proportional fairness metric for the plurality of UEs, and
wherein each of the first SSB sweeping pattern and the second SSB beam sweeping pattern is one of a first pattern of skipping transmission of an SSB for an area in which a small number of UEs are distributed among all SSBs, a second pattern of omitting transmission of an SSB for an area in which a small number of UEs are distributed among all of the SSBs, or a third pattern of repeatedly transmitting an SSB for an area in which a large number of UEs are distributed among all of the SSBs.

5. The method of claim 2, wherein the first location information comprises at least one of a global positioning system (GPS) coordinate, reference signal received power (RSRP) data, and a transmission configuration indication (TCI) state of the UEs.

6. An apparatus of a base station in a wireless communication system, the apparatus comprising:
a transceiver; and
at least one processor configured to:
determine a first synchronization signal block (SSB) beam sweeping pattern, based on distribution of a plurality of user equipments (UEs),
transmit information indicating the first SSB beam sweeping pattern to a neighbor base station and the plurality of UEs,
transmit an SSB to the plurality of UEs, based on the first SSB beam sweeping pattern,
receive information about an SSB beam sweeping pattern of the neighbor base station from the neighbor base station,
receive parameter information for updating the first SSB beam sweeping pattern from a core network,
update the first SSB beam sweeping pattern to a second SSB beam sweeping pattern, based on second location information received in response to a request transmitted to the plurality of UEs, based on the parameter information,
transmit information indicating the second SSB beam sweeping pattern to the neighbor base station and the plurality of UEs, and
transmit an SSB to the plurality of UEs, based on the second SSB beam sweeping pattern.

7. The apparatus of claim 6, wherein the at least one processor is further configured to:
determine the first SSB beam sweeping pattern by learning the distribution of the plurality of UEs, based on first location information received from the plurality of UEs and an artificial intelligence (AI) model;
cluster, by the AI model, the distribution of the plurality of UEs, based on the first location information; and
generate a representative UE distribution chart, based on a clustering result.

8. The apparatus of claim 6, wherein the parameter information is received from a network entity of the core network, and
wherein the parameter information comprises at least one of a number of UEs that have failed in initial connection, a number of UEs connected to the base station, and a cell IP throughput, and is received based on a key performance indicator (KPI) transmitted to the network entity.

9. The apparatus of claim 6, wherein each of the first SSB sweeping pattern and the second SSB beam sweeping pattern is determined based on a proportional fairness metric for the plurality of UEs, and
wherein each of the first SSB sweeping pattern and the second SSB beam sweeping pattern is one of a first pattern of skipping transmission of an SSB for an area in which a small number of UEs are distributed among all SSBs, a second pattern of omitting transmission of an SSB for an area in which a small number of UEs are distributed among all of the SSBs, or a third pattern of repeatedly transmitting an SSB for an area in which a large number of UEs are distributed among all of the SSBs.

10. The apparatus of claim 7, wherein the first location information comprises at least one of a global positioning system (GPS) coordinate, reference signal received power (RSRP) data, and a transmission configuration indication (TCI) state of the UEs.

11. A method performed by a user equipment (UE) in a wireless communication system, the method comprising:
transmitting first location information to a base station;
receiving configuration information about a first synchronization signal block (SSB) beam sweeping pattern from the base station;
receiving an SSB based on the first SSB beam sweeping pattern from the base station;
transmitting second location information to the base station;
receiving information indicating an update of the first SSB beam sweeping pattern to a second SSB beam sweeping pattern from the base station; and
receiving an SSB based on the second SSB beam sweeping pattern from the base station.

12. The method of claim 11, wherein transmitting the second location information is performed based on receiving a request message for updating the first SSB beam sweeping pattern to the second SSB beam sweeping pattern from the base station.

13. The method of claim 11, further comprising transmitting a message regarding whether to perform an energy saving (ES) mode to the base station.

14. The method of claim 11, further comprising receiving a measurement parameter comprising at least one of an SSB measurement timing configuration (SMTC) offset, an SMTC window, and a measurement period from the base station.

15. The method of claim 11, wherein the first location information comprises at least one of a global positioning system (GPS) coordinate, reference signal received power (RSRP) data, and a transmission configuration indication (TCI) state of the UE.

16. An apparatus of a user equipment (UE) in a wireless communication system, the apparatus comprising:
a transceiver; and
at least one processor configured to:
transmit first location information to a base station,
receive configuration information about a first synchronization signal block (SSB) beam sweeping pattern from the base station,
receive an SSB based on the first SSB beam sweeping pattern from the base station,
transmit second location information to the base station,
receive information indicating an update of the first SSB beam sweeping pattern to a second SSB beam sweeping pattern from the base station, and
receive an SSB based on the second SSB beam sweeping pattern from the base station.

17. The apparatus of claim 16, wherein the at least one processor is further configured to transmit the second location information, based on receiving a request message for updating the first SSB beam sweeping pattern to the second SSB beam sweeping pattern from the base station.

18. The apparatus of claim 16, wherein the at least one processor is further configured to transmit a message regarding whether to perform an energy saving (ES) mode to the base station.

19. The apparatus of claim 16, wherein the at least one processor is configured to receive a measurement parameter comprising at least one of an SSB measurement timing configuration (SMTC) offset, an SMTC window, and a measurement period from the base station.

20. The apparatus of claim 16, wherein the first location information comprises at least one of a global positioning system (GPS) coordinate, reference signal received power (RSRP) data, and a transmission configuration indication (TCI) state of the UE.
